(19) United States
(12) Patent Application Publication
(10) Pub. No.: US 2019/0202353 A1
(43) Pub. Date: Jul. 4, 2019

(54) Six-Division Around View Monitoring System for Assisted Driving and Method Thereof

(71) Applicant: ULSee Inc., Taipei City (TW)

(72) Inventor: Yi-Tsung Wu, Taipei City (TW)

(21) Appl. No.: 16/051,653

(22) Filed: Aug. 1, 2018

(30) Foreign Application Priority Data
Dec. 29, 2017 (CN) 201711477653.9

(51) Int. Cl. B60R 1/00; B60R 11/04

(52) U.S. Cl. CPC B60R 1/00; B60R 11/04; B60R 2300/605; B60R 2300/8026; B60R 2300/303; B60R 2300/105

(57) ABSTRACT

A six-division around view monitoring system is provided. The system includes a plurality of image sensing components, a data processing device and a display device. The image sensing components are respectively located at front side, rear side, left side, and right side of a vehicle, for respectively obtaining a front view image, a rear view image, a left view image and a right view image. The data processing device divides the left view image into a left-front view image and a left-rear view image according to a ratio, and divides the right view image into a right-front view image and a right-rear view image according to the ratio. The display device displays the front view image, the rear view image, the left-front view image, the left-rear view image, the right-front view image and the right-rear view image on a single picture to form a six-division around view image.

### FIELD OF THE DISCLOSURE

The present disclosure relates to a six-division around view monitoring system for assisted driving and method thereof; and more particularly to a six-division around view monitoring system using a plurality of cameras to generate six divisions of around view and method thereof.

### BACKGROUND OF THE INVENTION

With the advancement of technology, the performance of automobiles has also been continuously improved. How to improve the safety of driving is receiving considerable attention. An important factor for causing traffic accidents is that there are many dead corners during driving vehicles, which may result in traffic accidents easily. Especially during the process of parking the vehicles, it is easy to collide due to the dead corners since the distance between the vehicle and its surrounding vehicles or obstacles is relatively close.

However, traditional around view monitoring (AVM) system uses an image stitching method to present the front view image, the rear view image, the left view image and the right view image of the vehicle in a 2D stitching manner, which assists the driver to know the situation around the vehicle to avoid harming objects around the vehicle. This presentation (2D-AVM) makes the AVM system limited to small vehicles running at low speeds.

Hence, how to provide a six-division around view monitoring system for assisted driving at various speeds capable of solving the above-mentioned problems has become an important topic for the person skilled in the art.

### SUMMARY OF THE INVENTION

In view of the above-mentioned problems, a six-division around view monitoring system for assisted driving and method thereof are provided in the present disclosure, which can effectively allow drivers to clearly view images around vehicles to avoid traffic accidents.

It is one objective of the present disclosure to provide a six-division around view monitoring system for assisted driving.

According to one exemplary embodiment of the present disclosure, a six-division around view monitoring system for assisted driving is provided. The system includes a plurality of image sensing components, a data processing device and a display device. The plurality of image sensing components are respectively located at a front side, a rear side, a left side, and a right side of the vehicle, for respectively obtaining a front view image, a rear view image, a left view image and a right view image by capturing various angles of views around a vehicle. The data processing device is coupled to the plurality of image sensing components, for receiving the front view image, the rear view image, the left view image and the right view image, for dividing the left view image into a left-front view image and a left-rear view image according to a first ratio, and for dividing the right view image into a right-front view image and a right-rear view image according to a second ratio. The display device is coupled to the data processing device, for displaying the front view image, the rear view image, the left-front view image, the left-rear view image, the right-front view image and the right-rear view image on a single picture to form a six-division around view image.

In one example, each of the plurality of image sensing components is a fisheye lens.

In one example, the data processing device further includes a camera installation correction module for determining a camera installation position and a camera installation angle according to horizontal reference lines and radiation vertical reference lines in a calibration plate.

In one example, the data processing device further includes a fisheye image correction module for causing radiation vertical reference lines in each picture to be presented in a straight line.

In one example, the data processing device further includes a fisheye image correction module for determining the first ratio, the second ratio and lengths of the left-front view image, the left-rear view image, the right-front view image and the right-rear view image according to radiation vertical reference lines in a calibration plate.

In one example, the data processing device further includes a fisheye image correction module for performing a first angle of rotation of the left view image and a second angle of rotation of the right view image according to radiation vertical reference lines in a calibration plate.

In one example, the data processing device further includes a six-division image generation module for determining relevant parameters of a lookup table required to generate a static six-division image, and for generating a static six-division image.

In one example, the first ratio of the left-front view image to the left-rear view image is determined by a first distance from a front edge of the vehicle to a left side mirror and a second distance from the left side mirror to a rear edge of the vehicle, and the second ratio of the right-front view image to the right-rear view image is determined by a third distance from the front edge of the vehicle to a right side mirror and a fourth distance from the right side mirror to the rear edge of the vehicle.

In one example, the first ratio of the left-front view image to the left-rear view image is determined by a first distance from a front edge of the vehicle to a drive and a second distance from the driver to a rear edge of the vehicle, and the second ratio of the right-front view image to the right-rear view image is determined by a third distance from the front edge of the vehicle to the driver and a fourth distance from the driver to the rear edge of the vehicle.

It is one objective of the present disclosure to provide a method for using a plurality of cameras to generate six divisions of around view.

According to one exemplary embodiment of the present disclosure, a method for using a plurality of cameras to generate six divisions of around view is provided. The plurality of cameras is located at a front side, a rear side, a left side, and a right side of a vehicle. The method includes the following steps: using the plurality of cameras to respectively obtain a front view image, a rear view image, a left view image and a right view image by capturing various angles of views around the vehicle; receiving the front view image, the rear view image, the left view image and the right view image; dividing the left view image into a left-front view image and a left-rear view image according to a first ratio, and dividing the right view image into a right-front view image and a right-rear view image according to a second ratio; and displaying the front view image, the rear view image, the left-front view image, the left-rear view image, the right-front view image and the right-rear view image on a single picture to form a six-division around view image.

In one example, each of the plurality of cameras is a fisheye lens.

In one example, the method further includes the following step: determining a camera installation position and a camera installation angle according to horizontal reference lines and radiation vertical reference lines in a calibration plate.

In one example, the method further includes the following step: causing radiation vertical reference lines in each picture to be presented in a straight line.

In one example, the method further includes the following step: determining the first ratio, the second ratio and lengths of the left-front view image, the left-rear view image, the right-front view image and the right-rear view image according to radiation vertical reference lines in a calibration plate.

In one example, the method further includes the following step: performing a first angle of rotation of the left view image and a second angle of rotation of the right view image according to radiation vertical reference lines in a calibration plate.

In one example, the method further includes the following step: determining relevant parameters of a lookup table required to generate a static six-division image, and generating a static six-division image.

In one example, the first ratio of the left-front view image to the left-rear view image is determined by a first distance from a front edge of the vehicle to a left side mirror and a second distance from the left side mirror to a rear edge of the vehicle, and the second ratio of the right-front view image to the right-rear view image is determined by a third distance from the front edge of the vehicle to a right side mirror and a fourth distance from the right side mirror to the rear edge of the vehicle.

In one example, the first ratio of the left-front view image to the left-rear view image is determined by a first distance from a front edge of the vehicle to a drive and a second distance from the driver to a rear edge of the vehicle, and the second ratio of the right-front view image to the right-rear view image is determined by a third distance from the front edge of the vehicle to the driver and a fourth distance from the driver to the rear edge of the vehicle.

These and other objectives of the present disclosure will no doubt become obvious to those of ordinary skill in the art after reading the following detailed description of the preferred embodiment that is illustrated in the various figures and drawings.

### BRIEF DESCRIPTION OF THE DRAWINGS

FIG. 1 is a schematic diagram of a six-division around view monitoring system according to an embodiment of the present disclosure.

FIG. 2 is a schematic diagram of horizontal reference lines and radiation vertical reference lines according to an embodiment of the present disclosure.

FIG. 3 is a schematic diagram showing a vehicle bottom area and a screen position when cameras are installed according to an embodiment of the present disclosure.

FIG. 4 is a schematic diagram showing the horizontal reference lines being horizontally displayed as much as possible when the cameras are installed according to an embodiment of the present disclosure.

FIG. 5 is a schematic diagram showing the radiation vertical reference lines at both the left and right ends must be simultaneously seen when the cameras are installed according to an embodiment of the present disclosure.

FIG. 6 is a schematic diagram of the radiation vertical reference lines presented before and after correction of the fisheye lens according to an embodiment of the present disclosure.

FIG. 7 is a schematic diagram showing how to determine the lengths of the left-front view image, the left-rear view image, the right-front view image and the right-rear view image by using the distances between the cameras and the front edge and the rear edge of the vehicle according to an embodiment of the present disclosure.

FIG. 8 is a schematic diagram showing images before and after correction of the fisheye lens according to an embodiment of the present disclosure.

FIG. 9 is a schematic diagram of a lookup table for determining correction of the fisheye lens according to an embodiment of the present disclosure.

FIG. 10 is a flowchart illustrating the procedures of a method for using a plurality of cameras to generate six divisions of around view according to an embodiment of the present disclosure.

### DESCRIPTION OF THE PREFERRED EMBODIMENTS

Certain terms are used throughout the following descriptions and claims to refer to particular system components. As one skilled in the art will appreciate, manufacturers may refer to a component by different names. This document does not intend to distinguish between components that differ in name but not differ in functionality. In the following discussion and in the claims, the terms “include”, “including”, “comprise”, and “comprising” are used in an open-ended fashion, and thus should be interpreted to mean “including, but not limited to . . . ” The terms “couple” and “coupled” are intended to mean either an indirect or a direct electrical connection. Thus, if a first device couples to a second device, that connection may be through a direct electrical connection, or through an indirect electrical connection via other devices and connections.

The figures are only illustrations of an example, wherein the units or procedure shown in the figures are not necessarily essential for implementing the present disclosure. Those skilled in the art will understand that the units in the device in the example can be arranged in the device in the examples as described, or can be alternatively located in one or more devices different from that in the examples. The units in the examples described can be combined into one module or further divided into a plurality of sub-units.

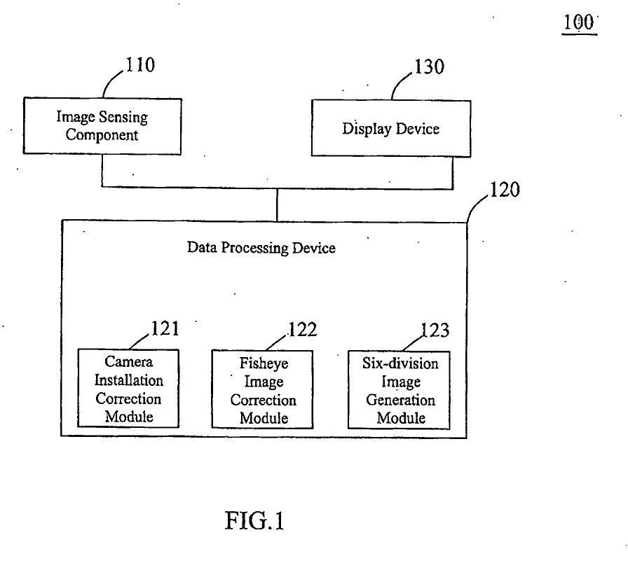

Please refer to FIG. 1. FIG. 1 is a schematic diagram of a six-division around view monitoring system 100 according to an embodiment of the present disclosure. As shown in FIG. 1, the six-division around view monitoring system 100 includes a plurality of image sensing components 110, a data processing device 120 and a display device 130. In this embodiment, each of the plurality of image sensing components 110 is a fisheye lens. Four fisheye lenses 110 are respectively located at a front side, a rear side, a left side, and a right side of the vehicle, for respectively obtaining a front view image, a rear view image, a left view image and a right view image by capturing various angles of views around the vehicle. The data processing device 120 is coupled to the plurality of image sensing components 110, for receiving the front view image, the rear view image, the left view image and the right view image, for dividing the left view image into a left-front view image and a left-rear view image according to a first ratio, and for dividing the right view image into a right-front view image and a right-rear view image according to a second ratio. The display device 30 is coupled to the data processing device 120, for displaying the front view image, the rear view image, the left-front view image, the left-rear view image, the right-front view image and the right-rear view image on a single picture to form a six-division around view image.

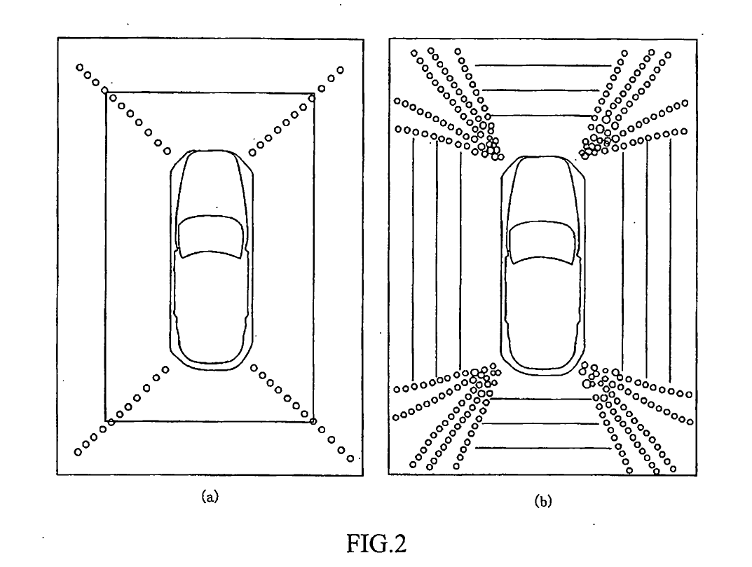

As shown in FIG. 1, the data processing device 120 further includes a camera installation correction module 121, a fisheye image correction module 122 and a six-division image generation module 123. The camera installation correction module 121 is used for determining a camera installation position and a camera installation angle according to horizontal reference lines and radiation vertical reference lines in a calibration plate. Please refer to FIG. 2. FIG. 2 is a schematic diagram of horizontal reference lines and radiation vertical reference lines according to an embodiment of the present disclosure. In this embodiment, FIG. 2(a) shows the simplest design of the calibration plate. In another embodiment of the present disclosure, there are more complex designs (as shown in FIG. 2(b)) in response to different cameras (e.g., different resolutions).

Basically, the installation positions of the four cameras (front, rear, left and right) in actual installation will be determined according to the following three conditions.

A1.1

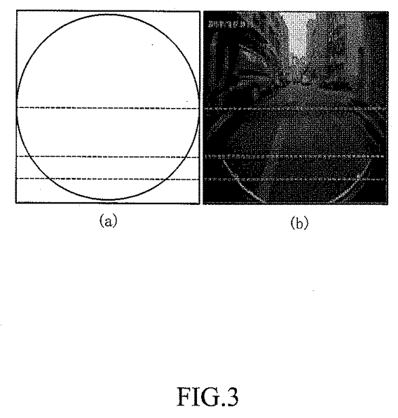

Please refer to FIG. 3. FIG. 3 is a schematic diagram showing a vehicle bottom area and a screen position when cameras are installed according to an embodiment of the present disclosure. When the cameras are installed, the angles of the lenses need to be able to see the vehicle bottom. At the same time, the vehicle bottom needs to be appeared at one-eighth of the bottom of the picture, as is shown in FIG. 3(a). FIG. 3(b) is the result of actual installation.

A1.2

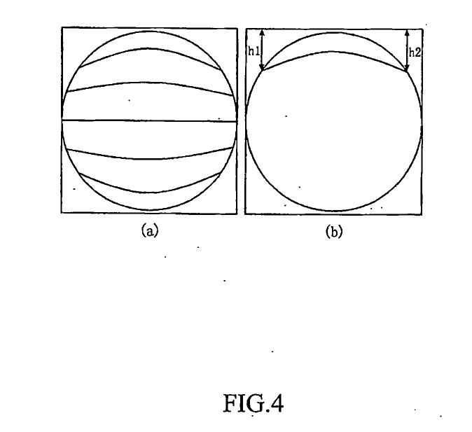

Please refer to FIG. 4. FIG. 4 is a schematic diagram showing the horizontal reference lines being horizontally displayed as much as possible when the cameras are installed according to an embodiment of the present disclosure. The horizontal reference lines seen by the camera need to be rendered as horizontally as possible in the picture. FIG. 4(a) is a schematic diagram of the horizontal reference lines observed by the camera. However, in the fisheye lens image, only the middle horizontal line is presented horizontally, the other horizontal reference lines will be presented in an arc line. At this point, you can use the positions of the two endpoints of the are line in the picture to evaluate whether the lens is at a horizontal position or not, as is shown in FIG. 4(b). In FIG. 4(b), if the length “h1” is almost equal to the length “h2”, it means that the picture is at a horizontal position.

A1.3

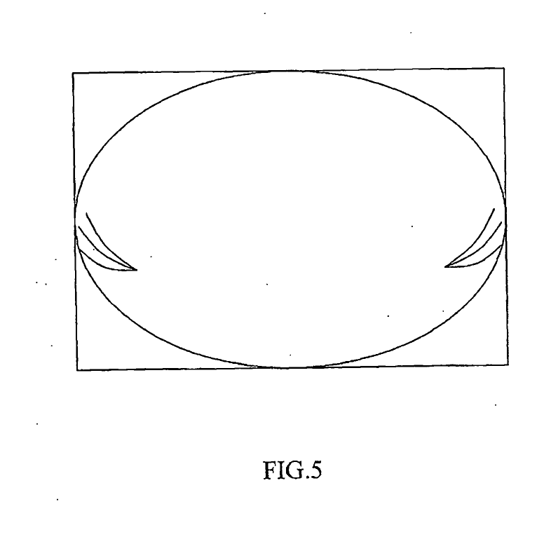

Please refer to FIG. 5. FIG. 5 is a schematic diagram showing the radiation vertical reference lines at both the left and right ends must be simultaneously seen when the cameras are installed according to an embodiment of the present disclosure. The cameras of the present disclosure need to be able to simultaneously see the radiation vertical reference lines at both the left and right sides.

Step A2

The fisheye image correction module 122 of the present disclosure completes the left and right images by using the radiation vertical reference lines in the calibration plate, and determines the lengths of the left-front view image, the left-rear view image, the right-front view image and the right-rear view image. This Step A2 includes the following two sub-steps:

A2.1

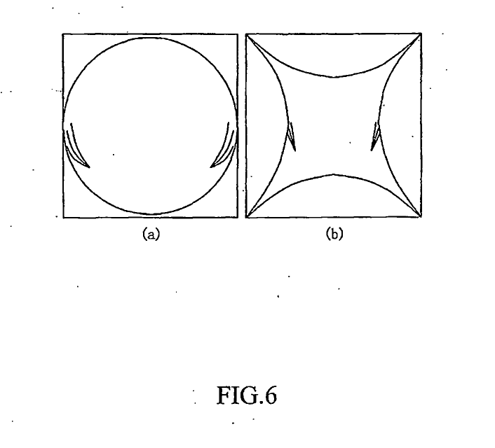

The fisheye image correction module 122 is used for performing a fisheye image correction. Please refer to FIG. 6. FIG. 6 is a schematic diagram of the radiation vertical reference lines presented before and after correction of the fisheye lenses according to an embodiment of the present disclosure. In order to improve the performance of image stitching, the fisheye image correction module 122 performs fisheye image correction, so that the radiation vertical reference lines in each picture are presented in a straight line. FIG. 6(a) shows the original fisheye image, and FIG. 6(b) shows the image after correction of the fisheye lenses.

A2.2

The fisheye image correction module 122 is used for determining the lengths of the left-front view image, the left-rear view image, the right-front view image and the right-rear view image.

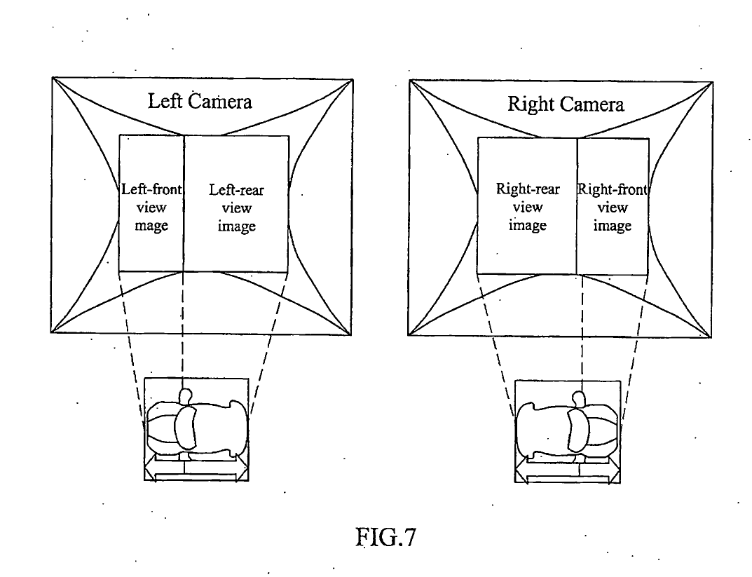

Please refer to FIG. 7. FIG. 7 is a schematic diagram showing how to determine the lengths of the left-front view image, the left-rear view image, the right-front view image and the right-rear view image by using the distances between the cameras and the front edge and the rear edge of the vehicle according to an embodiment of the present disclosure. The fisheye image correction module 122 of the present disclosure determines the first ratio, the second ratio and the lengths of the left-front view image, the left-rear view image, the right-front view image and the right-rear view image by using the distances between the cameras and the front edge and the rear edge of the vehicle according to the left view image and the right view image.

Be noted that, in one embodiment of the present disclosure, the first ratio of the left-front view image to the left-rear view image is determined by a first distance from a front edge of the vehicle to a left side mirror and a second distance from the left side mirror to a rear edge of the vehicle, and the second ratio of the right-front view image to the right-rear view image is determined by a third distance from the front edge of the vehicle to a right side mirror and a fourth distance from the right side mirror to the rear edge of the vehicle. In another embodiment of the present disclosure, the first ratio of the left-front view image to the left-rear view image is determined by a first distance from a front edge of the vehicle to a drive and a second distance from the driver to a rear edge of the vehicle, and the second ratio of the right-front view image to the right-rear view image is determined by a third distance from the front edge of the vehicle to the driver and a fourth distance from the driver to the rear edge of the vehicle.

Step A3

The six-division image generation module 123 is used for determining relevant parameters of a lookup table required to generate a static six-division image and for generating a static six-division image. Through the above two steps, the six-division image generation module 123 may determine the following two important parameters: the parameters of the fisheye correction, and the lengths of the left-front view image, the left-rear view image, the right-front view image and the right-rear view image. The relevant parameters of the lookup table of the image may be generated based on the above important parameters, and the result of the first stage static six-division image can be generated. The detailed description of this step is as follows.

A3.1

A lookup table that determines fisheye correction.

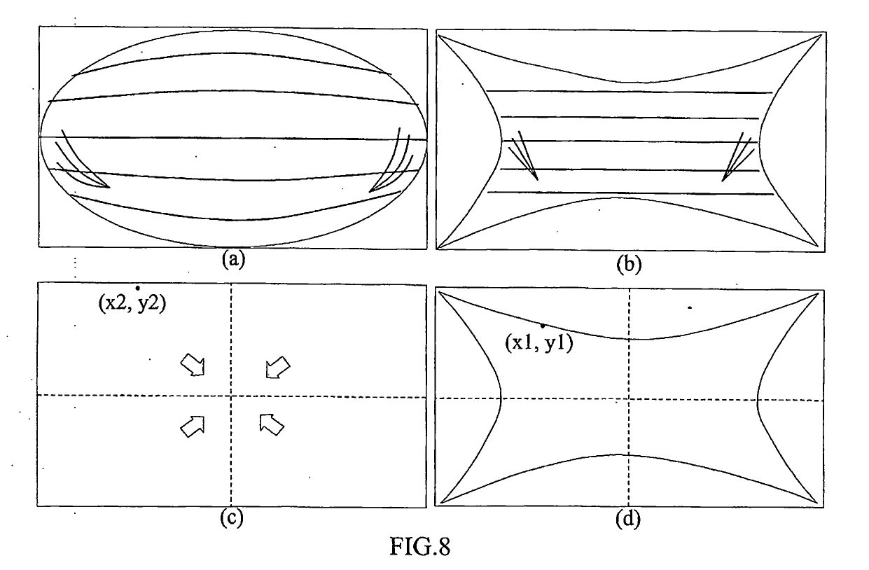

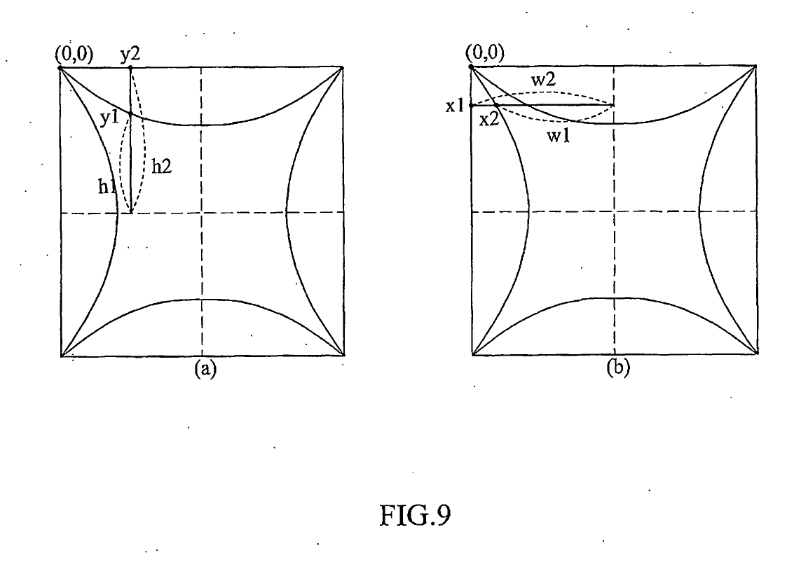

Please refer to FIG. 8. FIG. 8 is a schematic diagram showing images before and after correction of the fisheye lens according to an embodiment of the present disclosure. As shown in FIG. 8(a), the horizontal reference lines and radiation vertical reference lines on the calibration plate are presented in a curved line due to the fisheye lens. The result after the fisheye image correction is shown in FIG. 8(b). Basically, the horizontal reference lines and radiation vertical reference lines on the calibration plate are restored to a straight line, which represents that the procedure for the fisheye image correction is completed. In short, the fisheye correction procedure mainly determines a set of most appropriate elliptical radians parameters in X and Y axes of the image, and then compresses all pixels of the image to the center of the image according to the parameters, as shown in FIG. 8(c) and FIG. 8(d). Assume that FIG. 8(c) is the original image, and FIG. 8(d) is obtained after the fisheye correction procedure is performed. The point (x1, y1) shown in FIG. 8(d) is corresponding to the point (x2, y2) in FIG. 8(c). The lookup table for fisheye correction is mainly used for finding out the coordinate position (x2,y2) in the original image corresponding to each pixel (with the coordinate position (x1, y1)) in the corrected fisheye image. Therefore, there are at least two lookup tables of “X-axis coordinate” and “Y-axis coordinate”. A description of how to build a lookup table is shown in FIG. 9. Please refer to FIG. 9. FIG. 9 is a schematic diagram of a lookup table for determining correction of the fisheye lens according to an embodiment of the present disclosure. FIG. 9(a) illustrates the method for determining the lookup table of “Y-axis coordinate”. The two points (x1, y1) and (x2, y2) on the black thick line in FIG. 9(a) indicate the corresponding coordinate positions of the “fisheye image” and the “corrected image”, respectively. Please note that “x2” and “y2” are unknown values. Herein, “h1” and “h2” represent the heights of the two points to the center line of the image, respectively. Based on the principle of equivalence, the formula (1) can be obtained, and then the formula (2) can be obtained after derivation. In other words, “y2” is the value of the coordinate point (x1, y1) in the “Y-axis lookup table”.

$$\begin{matrix}\frac{{h}_{1}}{{h}_{2}} = \frac{{h}_{2} - {y}_{1}}{{h}_{2} - {y}_{2}} . & ( 1 ) \\ {y}_{2} = \frac{{h}_{2}^{2} - {h}_{1} * {h}_{2} - {h}_{2} * {y}_{1}}{{h}_{1}} . & ( 2 )\end{matrix}$$

By using the same method (as shown in FIG. 9(b)), the value “x2” of the coordinate point (x1,y1) in the “X-axis lookup table” can be derived by the formula (3), wherein “w1” and “w2” represent the widths of the two points to the center line of the image.

$${x}_{2} = \frac{{w}_{1} * {w}_{2} - {w}_{2}^{2} + {w}_{2} * {x}_{1}}{{w}_{1}} . \qquad ( 3 )$$

A six-division around view monitoring system for assist driving is provided in the present disclosure, which can effectively enable drivers to clearly view the images around the vehicle to avoid occurrence of traffic accidents. In addition, a six-division around view monitoring system with 6 or 8 or more lenses on the market can save more cost.

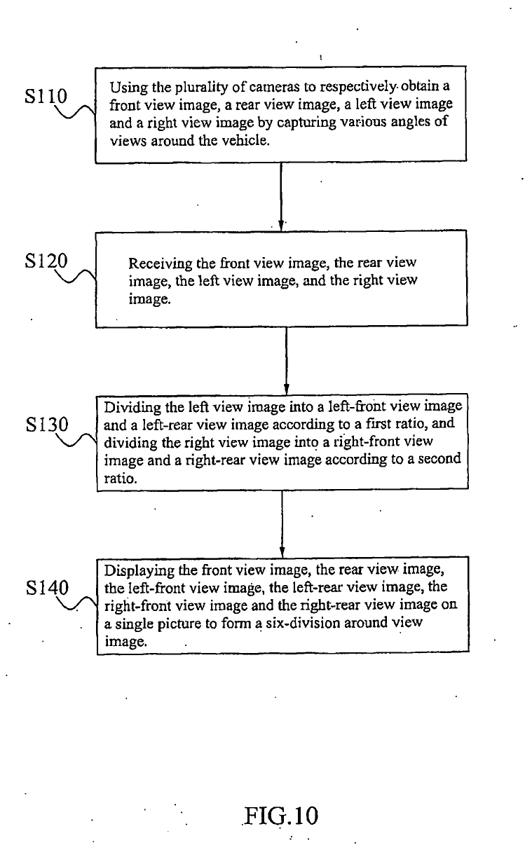

Please refer to FIG. 10. FIG. 10 is a flowchart illustrating the procedures of a method for using a plurality of cameras to generate six divisions of around view according to an embodiment of the present disclosure. The plurality of cameras is located at a front side, a rear side, a left side, and a right side of a vehicle. The method includes the following steps. In step S110, using the plurality of cameras to respectively obtain a front view image, a rear view image, a left view image and a right view image by capturing various angles of views around the vehicle; in step S120, receiving the front view image, the rear view image, the left view image and the right view image; in step S130, dividing the left view image into a left-front view image and a left-rear view image according to a first ratio, and dividing the right view image into a right-front view image and a right-rear view image according to a second ratio; and in step S140 displaying the front view image, the rear view image, the left-front view image, the left-rear view image, the right-front view image and the right-rear view image on a single picture to form a six-division around view image.

In one example, each of the plurality of cameras is a fisheye lens.

In one example, the method further includes the following step: determining a camera installation position and a camera installation angle according to horizontal reference lines and radiation vertical reference lines in a calibration plate.

In one example, the method further includes the following step: causing radiation vertical reference lines in each picture to be presented in a straight line.

In one example, the method further includes the following step: determining the first ratio, the second ratio and lengths of the left-front view image, the left-rear view image, the right-front view image and the right-rear view image according to radiation vertical reference lines in a calibration plate.

In one example, the method further includes the following step: performing a first angle of rotation of the left view image and a second angle of rotation of the right view image according to radiation vertical reference lines in a calibration plate.

In one example, the method further includes the following step: determining relevant parameters of a lookup table required to generate a static six-division image, and generating a static six-division image.

In one example, the first ratio of the left-front view image to the left-rear view image is determined by a first distance from a front edge of the vehicle to a left side mirror and a second distance from the left side mirror to a rear edge of the vehicle, and the second ratio of the right-front view image to the right-rear view image is determined by a third distance from the front edge of the vehicle to a right side mirror and a fourth distance from the right side mirror to the rear edge of the vehicle.

In one example, the first ratio of the left-front view image to the left-rear view image is determined by a first distance from a front edge of the vehicle to a drive and a second distance from the driver to a rear edge of the vehicle, and the second ratio of the right-front view image to the right-rear view image is determined by a third distance from the front edge of the vehicle to the driver and a fourth distance from the driver to the rear edge of the vehicle.

Reference in the specification to “one example” or “an example” means that a particular feature, structure, or characteristic described in connection with the example is included in at least an implementation. The appearances of the phrase “in one example” in various places in the specification are not necessarily all referring to the same example. Thus, although examples have been described in language specific to structural features and/or methodological acts, it is to be understood that claimed subject matter may not be limited to the specific features or acts described. Rather, the specific features and acts are disclosed as sample forms of implementing the claimed subject matter.

The above are only preferred examples of the present disclosure is not intended to limit the present disclosure within the spirit and principles of the present disclosure, any changes made, equivalent replacement, or improvement in the protection of the present disclosure should contain within the range.

Those skilled in the art will readily observe that numerous modifications and alterations of the device and method may be made while retaining the teachings of the invention. Accordingly, the above disclosure should be construed as limited only by the meters and bounds of the appended claims.

What is claimed is:

1. A six-division around view monitoring system for assisted driving, applied to a vehicle, comprising:
a plurality of image sensing components, respectively located at a front side, a rear side, a left side, and a right side of the vehicle, for respectively obtaining a front view image, a rear view image, a left view image and a right view image by capturing various angles of views around the vehicle;
a data processing device, coupled to the plurality of image sensing components, for receiving the front view image, the rear view image, the left view image and the right view image, for dividing the left view image into a left-front view image and a left-rear view image according to a first ratio, and for dividing the right view image into a right-front view image and a right-rear view image according to a second ratio; and
a display device, coupled to the data processing device, for displaying the front view image, the rear view image, the left-front view image, the left-rear view image, the right-front view image and the right-rear view image on a single picture to form a six-division around view image.

2. The six-division around view monitoring system according to claim 1, wherein each of the plurality of image sensing components is a fisheye lens.

3. The six-division around view monitoring system according to claim 1, wherein the data processing device further comprises a camera installation correction module for determining a camera installation position and a camera installation angle according to horizontal reference lines and radiation vertical reference lines in a calibration plate.

4. The six-division around view monitoring system according to claim 1, wherein the data processing device further comprises a fisheye image correction module for causing radiation vertical reference lines in each picture to be presented in a straight line.

5. The six-division around view monitoring system according to claim 1, wherein the data processing device further comprises a fisheye image correction module for determining the first ratio, the second ratio and lengths of the left-front view image, the left-rear view image, the right-front view image and the right-rear view image according to radiation vertical reference lines in a calibration plate.

6. The six-division around view monitoring system according to claim 1, wherein the data processing device further comprises a fisheye image correction module for performing a first angle of rotation of the left view image and a second angle of rotation of the right view image according to radiation vertical reference lines in a calibration plate.

7. The six-division around view monitoring system according to claim 1, wherein the data processing device further comprises a six-division image generation module for determining relevant parameters of a lookup table required to generate a static six-division image and for generating a static six-division image.

8. The six-division around view monitoring system according to claim 1, wherein the first ratio of the left-front view image to the left-rear view image is determined by a first distance from a front edge of the vehicle to a left side mirror and a second distance from the left side mirror to a rear edge of the vehicle, and the second ratio of the right-front view image to the right-rear view image is determined by a third distance from the front edge of the vehicle to a right side mirror and a fourth distance from the right side mirror to the rear edge of the vehicle.

9. The six-division around view monitoring system according to claim 1, wherein the first ratio of the left-front view image to the left-rear view image is determined by a first distance from a front edge of the vehicle to a drive and a second distance from the driver to a rear edge of the vehicle, and the second ratio of the right-front view image to the right-rear view image is determined by a third distance from the front edge of the vehicle to the driver and a fourth distance from the driver to the rear edge of the vehicle.

10. A method for using a plurality of cameras to generate six divisions of around view, a plurality of cameras are located at a front side, a rear side, a left side, and a right side of a vehicle, the method comprising:
using the plurality of cameras to respectively obtain a front view image, a rear view image, a left view image and a right view image by capturing various angles of views around the vehicle;
receiving the front view image, the rear view image, the left view image and the right view image;
dividing the left view image into a left-front view image and a left-rear view image according to a first ratio, and dividing the right view image into a right-front view image and a right-rear view image according to a second ratio; and
displaying the front view image, the rear view image, the left-front view image, the left-rear view image, the right-front view image and the right-rear view image on a single picture to form a six-division around view image.

11. The method according to claim 10, wherein each of the plurality of cameras is a fisheye lens.

12. The method according to claim 10, further comprising:
determining a camera installation position and a camera installation angle according to horizontal reference lines and radiation vertical reference lines in a calibration plate.

13. The method according to claim 10, further comprising:
causing radiation vertical reference lines in each picture to be presented in a straight line.

14. The method according to claim 10, further comprising:
determining the first ratio, the second ratio and lengths of the left-front view image, the left-rear view image, the right-front view image and the right-rear view image according to radiation vertical reference lines in a calibration plate.

15. The method according to claim 10, further comprising:
performing a first angle of rotation of the left view image and a second angle of rotation of the right view image according to radiation vertical reference lines in a calibration plate.

16. The method according to claim 10, further comprising:
determining relevant parameters of a lookup table required to generate a static six-division image, and generating a static six-division image.

17. The method according to claim 10, wherein the first ratio of the left-front view image to the left-rear view image is determined by a first distance from a front edge of the vehicle to a left side mirror and a second distance from the left side mirror to a rear edge of the vehicle, and the second ratio of the right-front view image to the right-rear view image is determined by a third distance from the front edge of the vehicle to a right side mirror and a fourth distance from the right side mirror to the rear edge of the vehicle.

18. The method according to claim 10, wherein the first ratio of the left-front view image to the left-rear view image is determined by, a first distance from a front edge of the vehicle to a drive and a second distance from the driver to a rear edge of the vehicle, and the second ratio of the right-front view image to the right-rear view image is determined by a third distance from the front edge of the vehicle to the driver and a fourth distance from the driver to the rear edge of the vehicle.
